(19) United States
(12) Patent Application Publication
(10) Pub. No.: US 2009/0293349 A1
(43) Pub. Date: Dec. 3, 2009

(54) Plant Protection Apparatus

(76) Inventor: Steve Dunbar, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 12/476,988

(22) Filed: Jun. 2, 2009

Related U.S. Application Data
(60) Provisional application No. 61/058,429, filed on Jun. 3, 2008.

(51) Int. Cl. A01G 13/02

(52) U.S. Cl. 47/20.1

(57) ABSTRACT

An apparatus for protecting plants is includes a covering that has a means for opening and closing the covering, an element that may be for heating or cooling and is releaseably attached to the protective covering and a means for securing the covering around the plant.

### CROSS-REFERENCE TO RELATED APPLICATION

This application claims the benefit for priority of U.S. Provisional Application No. 61/058,429 filed Jun. 3, 2008, which is incorporated herein by reference in its entirety for all purposes.

### BACKGROUND

The application relates generally to a protective device, and more particularly, to an apparatus for protecting plants from one or a number of external conditions.

Plants provide a tremendous benefit to human-kind both as a food source and as a source for decoration. Despite best efforts, plants are often damaged, especially in areas in which there are changes in external conditions, such as changes in temperature, diseases, insects, livestock or other animals, as examples. Initial attempts to protect plants include devices that are either cumbersome to set up, administer and/or store or are expensive to manufacture or maintain.

### SUMMARY

The apparatus disclosed herein relates to a protective device for plants that solves one or more problems observed in the prior art.

Generally, a plant protector described herein includes a protective covering having an opening-closing strip, a powered heating element attached to the protective covering, and/or a timer and thermostat connected to the heating element. Additional features include an element for securing the covering to a plant that may be potted or planted in the ground.

The plant protector may include a protective covering, wherein the protective covering includes a means for opening and closing said protective covering, an element releaseably attached to the protective covering, a means for powering the element; and a means for securing the protective covering around the plant. It may further comprise a timer operably connected to the element, and/or a thermostat operably connected to the element. The means for opening and closing the protective covering may be in the form of a strip. The means for powering the element may be a power plug connected to an AC power source. The means for powering the element may be a power plug connected to a DC power source. The means for powering the element may be a rechargeable battery pack. The means for powering the element may be solar. The means for securing the protective covering around the plant may be a drawstring. The protective covering may be closed at its top end. The protective covering may be open at its top and bottom end.

Additionally is described an apparatus for protecting a plant that includes a covering having a top and bottom end and a seam, wherein the covering includes a releasable element in its interior that is powered for heating or cooling, wherein the covering includes a means for opening and closing the seam and wherein a means for securing the covering brings the covering in close proximity to the plant. The apparatus may further comprise a timer operably connected to the element and/or a thermostat operably connected to the element. The means for opening and closing the protective covering may be selected from the group consisting of one or a number of hook and latches, clamps, clasps, buttons, zippers, hooks and combinations thereof. The releasable element may be powered by one of the group selected from a power plug connected to an AC power source, a power plug connected to a DC power source, a rechargeable battery pack, a solar source. The means for securing the protective covering around the plant may be selected from the group consisting of a string, clamp, clasp, zipper, hook, latch, button, elastic, rubber band, and combinations thereof. The protective covering may be closed at its top end. The protective covering may be open at its top and bottom end. The protective covering may be transported in a carrying case.

Those skilled in the art will further appreciate the above-noted features and advantages of the invention together with other important aspects thereof upon reading the detailed description that follows and in conjunction with the drawings

### BRIEF DESCRIPTION OF THE DRAWINGS

For more complete understanding of the features and advantages of the inventions described herein, reference is now made to a description of the invention along with accompanying figures, wherein:

FIG. 1 depicts a perspective drawing of a representative embodiment of an apparatus described herein;

FIG. 2A depicts a representative interior view of an apparatus described herein;

FIG. 2B depicts a representative exterior view of an apparatus described herein;

FIG. 2C depicts a top view of an apparatus described herein;

FIG. 3A depicts a partially closed view of a representative apparatus as described herein;

FIG. 3B depicts another representative interior view of an apparatus described herein;

FIG. 3C depicts another top view of an apparatus described herein.

### DESCRIPTION

Although making and using various embodiments are discussed in detail below, it should be appreciated that the description provides many inventive concepts that may be embodied in a wide variety of contexts. Any specific embodiments discussed herein are merely illustrative of ways to make and use the invention, and do not limit the scope of the invention.

References will now be made to the drawings wherein like numerals refer to like or similar parts throughout. The drawing figures are not necessarily to scale and certain features may be shown exaggerated in scale or in somewhat generalized or schematic form in the interest of clarity and conciseness.

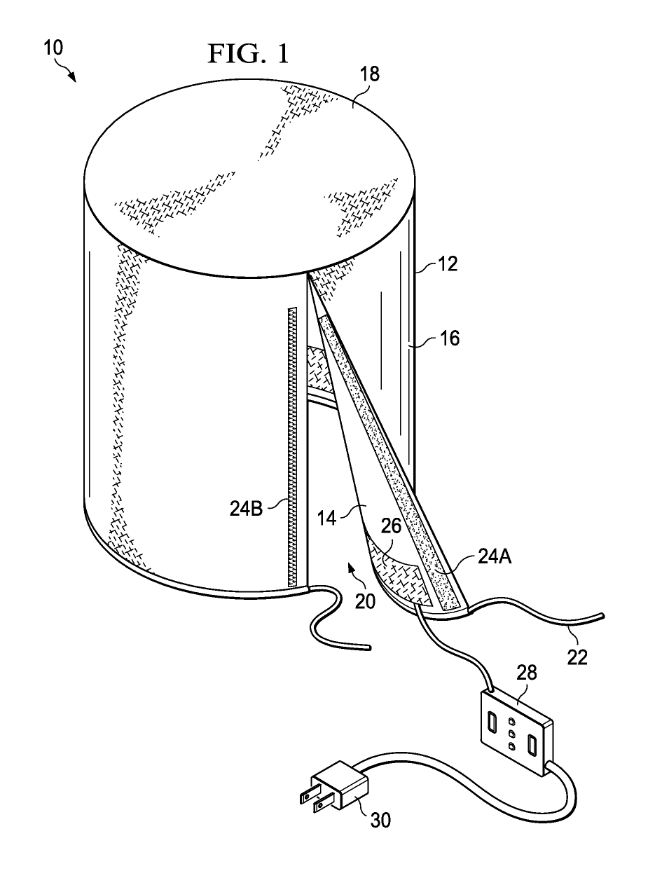

Referring now to FIG. 1, a representative example of an apparatus for protecting plants is shown. Protector 10 as depicted in FIG. 1 is in the form of a circular or cylindrical-shape. However, alternative shapes are possible and any practical shape may be made as desired, determined, in part, by the plant to be protected. Apparatus 10 includes covering 12 which has a top edge 11 and a bottom edge 13. Generally, a covering as depicted in FIG. 1 may also include an interior wall 14, sidewalls 15 and 17, exterior wall 16, a top end panel 18 and a first opening 20. Walls 14 and 16 may be formed from a single material, from more than one material forming a single layer or from one or more materials forming one or more layers.

The material comprises one that may be shaped and may hold its shape after forming. When desired, the material is water repellant. Covering 12 is preferably constructed of a material that is breathable (thereby porous), repels water and prevents water accumulation on the exterior surface. The material used to manufacture the covering should also offer suitable flexibility to hold a shape and allow for easy storage. In one example, the covering 12 is constructed of a material that allows the apparatus to be stored in a back pack, storage bag or other small space. In one or more embodiments, a preferred material is a spun-bound polypropylene. Other suitable materials include but are not limited to fabrics that are of natural and/or synthetic materials and combinations thereof, including burlap and linen.

When covering 12 includes a top end panel, it is attached in such a way to form a seam between the top end panel and the top edge of the covering, which may include one or more walls (e.g., exterior wall 16, interior wall 14). In an alternate embodiment, a top edge of walls 14 and/or 16 may be sewn together, removing a need for top end panel 18. When top end panel 18 is in place, a seam formed between the top end panel and the top edge of the covering may be formed. In one or more embodiments, sidewalls 15 and 17 are constructed in such a manner to include a seam having an opening which runs the entirety of the sidewalls. Such a construction may be modified as desired to provide a seam at various lengths from the top and/or bottom. One of ordinary skill in the art may make such adjustments without undue experimentation when appropriate. A means for closing the one or more seams along the sidewalls are provided by a number of options. In one or more embodiments, a hook and latch strip as depicted by 24A and 24B may be included to allow protector 10 to be secured easily around a plant and with equal ease, it can be removed from the plant. In lieu of strip 24, the seam may be opened and/or closed using any of a number of means, including individual hook and latches, one or number of clamps, clasps, buttons, zippers or any other means suitable for opening and closing a seam, in any desired combination.

Covering 12 is generally fabricated with the addition of a means for a drawing the covering tightly at its bottom end. As embodied in FIG. 1, a means is provided as 22 which secures the covering 12 around its base. As an alternative, a means for securing the covering may be provided at the top end of the covering. Any such configuration will be suited for covering a plant, whether it be potted plant, seedling, bush or in the alternative a shrub or tall tree. Suitable means include strings, latches, clasps, buttons, or any other means suitable for securing and/or tightening and end of the covering.

As described, when interior wall 14, exterior wall 16, and the top end panel 18 are formed, they are combined in such a way to create a first opening 20. In the absence of top end panel 18, a second opening on the top end will be provided.

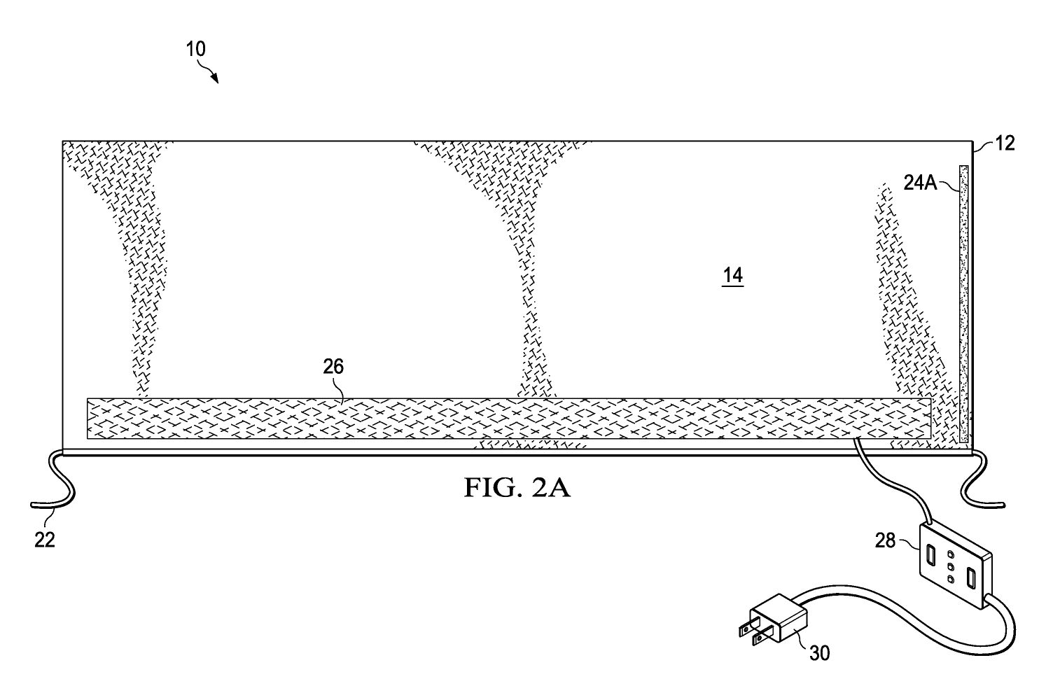

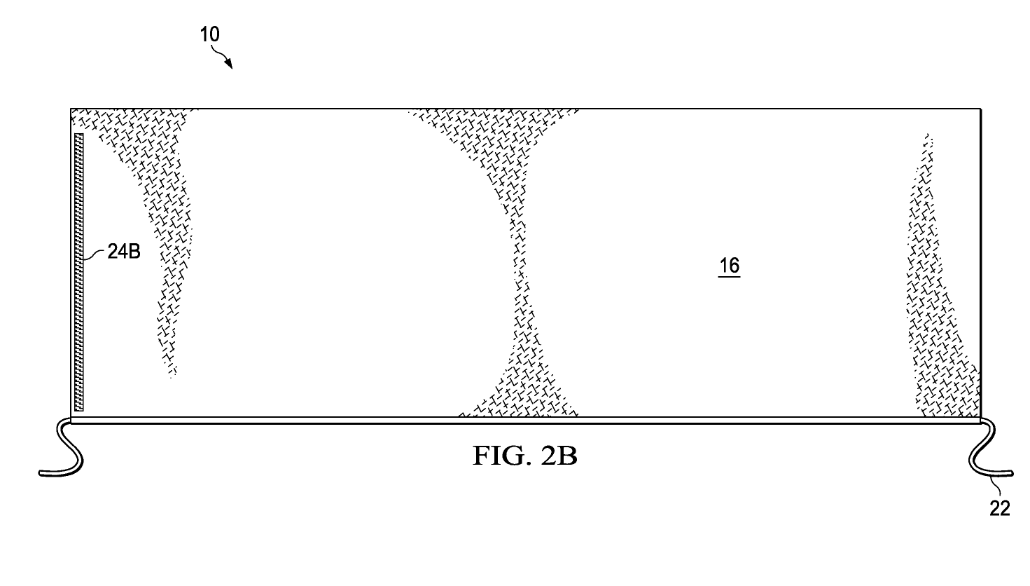

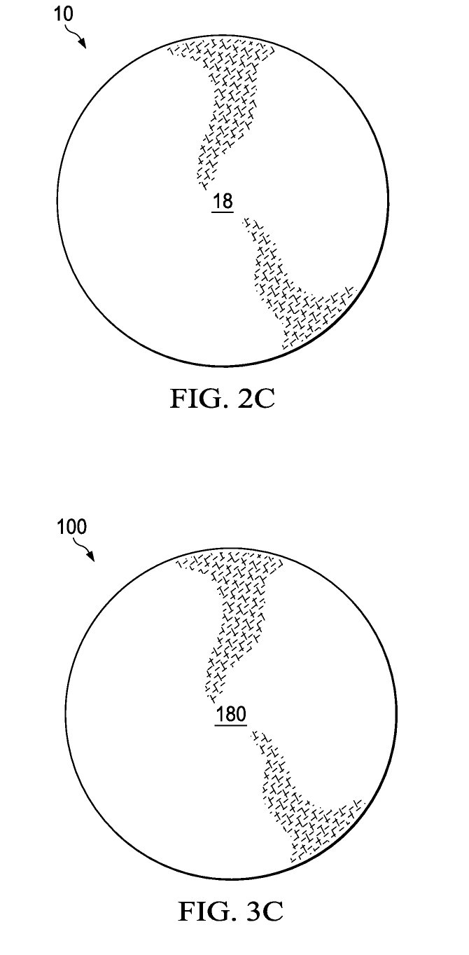

Referring now to FIG. 2A, an interior view of the plant protector 10 is illustrated. FIG. 2A shows the covering 12 of protector 10, the interior wall 14, the means for securing 22, a first portion of strip 24A, a receding element 26, a supplemental accessory 28 and a plug 30.

A receding element 26 as shown in FIG. 1 and FIG. 2A is typically attached in a releasable fashion to interior wall 14 of the protector 10. Element 26 is generally provided as a heating element and may be in any shape. In FIG. 2A it is depicted along the lower end of protector 10. It may also be provided at other positions and at one or more various locations. The element is not required to be shaped as depicted in the figures, and may be any shape and located in any portion of interior wall 14. Element 26 will be positioned where suited to raise the ambient temperature inside covering 12 or to maintain a desired temperature. In one or more embodiments, element 26 is a heating element for protecting plants against frost and freezing conditions. Element 26 may also include or be replaced by a cooling element. The element may be operated by battery, electricity and/or by other means, such as solar.

FIG. 2B illustrates an outside view of the protector 10. FIG. 2B illustrates the exterior wall 16 of covering 12, the mating portion of the seam means, depicted as 24B, useful for opening and closing covering 12. Again 24A and 24B may be any suitable mating partner useful for closing a seam, such as a hook and latch strip, clamp, clasp, button, zipper, string, and combinations thereof.

FIG. 2C is a top view of a protector 10 having a closed end panel 18. Such a configuration is suitable for smaller bushes, trees or low-lying plants. Again, the embodiments disclosed are depicted as circular in shape and having a closed end panel 18; however, other shapes with or without a closed upper end panel are well within the fabrication of a protector as described herein. Alternative shapes for protector 10 include but are not limited to conical shape, pyramidal shape, square shape, rectangular shape, and the like.

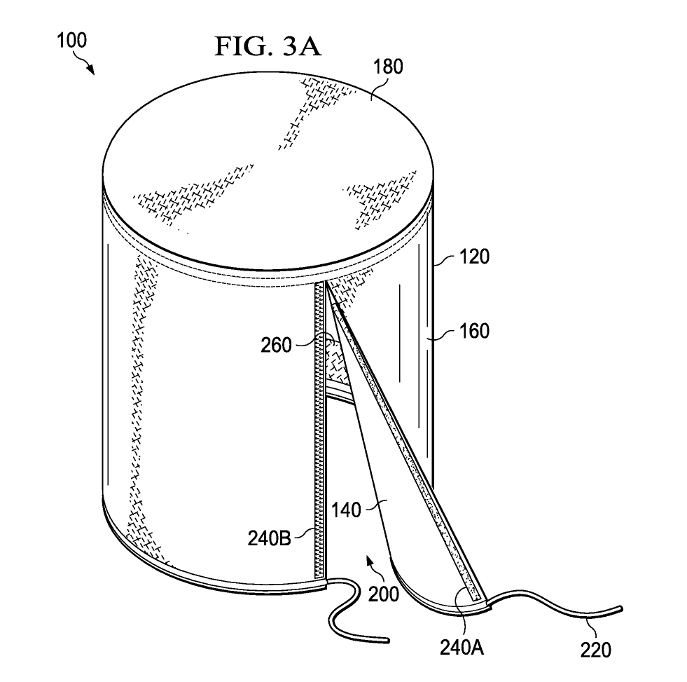

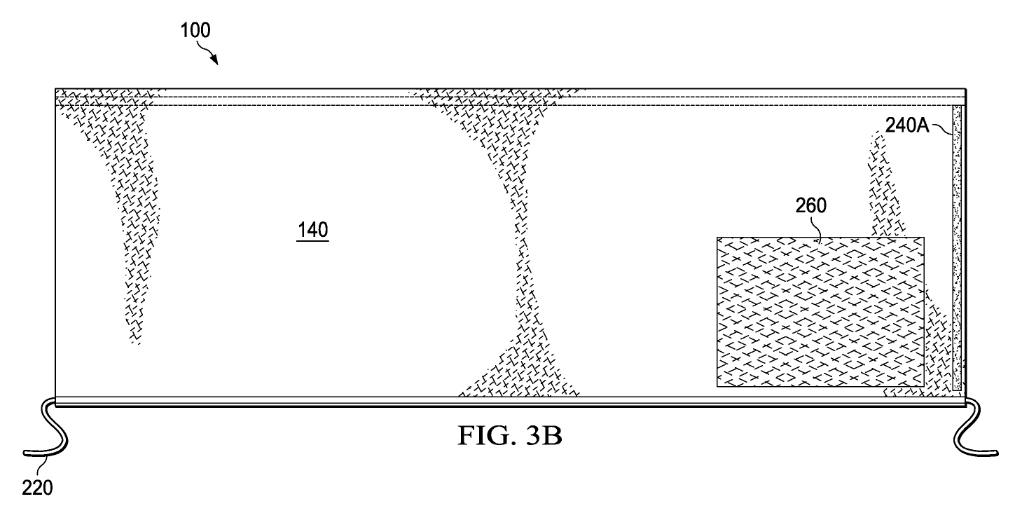

FIG. 3 shows a perspective view of another representative protector.

As disclosed with the figures and description, an apparatus for protecting a plant generally includes a covering, an element, at least one means for securing the covering at a base and/or its upper end, and at least one means for opening and closing the covering at a seam. Accessories for the element may include but are not limited to batteries (rechargeable or non-rechargeable), a solar panel, a fan, a power plug, a timer, and a thermostat.

One representative embodiment includes a covering having a seam from top to bottom, a covered top end, a drawstring at its base, a Velcro™ strip for opening and closing a seam, a heating element relying on a rechargeable battery pack, a power plug, a timer, and thermostat.

As described, a protector servers a number of functions. For example, as a covering, it provides the first line of defense for protecting a plant against environmental elements, such as frost, ice, hail, strong winds, etc. In addition, a protector described herein protects against other environmental problems, including insects and small animals, which may damage the plants. The protection provided by the apparatus described herein may be especially critical when plants are initially planted, as they are less able to withstand the attacks from insects and small animals.

In several embodiments, a protector includes a removable heating element designed to keep plants at a preferred temperature, especially during inclement weather. The heating element 14 may be sewn to the covering, attached by a hook and latch mechanism, or other suitable means, including clamps, clasps, buttons, adhesives, zippers or the like. The heating element 14 is preferably connected to a thermostat 26 and a timer 24 for regulation of temperature at a preferred range.

By connecting the heating element to a thermostat, a user of the plant protector may set the temperature inside the plant protector to a desired temperature range dictated by the growth cycle of the plant or the environmental conditions where the plant resides. An addition connection to a timer 26, permits the user of the plant protector to operate the heating element 14 for a predetermined and desired time period. For example, the timer is set to operate the heating element to run for a two hour time period and then shut off for another two hour time period, which may be continued indefinitely. This example provides heat inside the covering and prevents frost on the plant as well as damage to the plant.

Heating element is powered by connecting the power plug 22 to a power outlet for supplying AC power (not shown). Alternatively, the heating element 14 can also be powered using a rechargeable battery pack, a solar powered battery pack, a DC power source, or other suitable means and desired combinations.

In the exemplary embodiments referenced above, the protective covering is fabricated from a lightweight material that repels water and allows the plant protector to be easily stored without adding significant weight to a plant, including a seedling. The protective covering may be transported in a carrying case; the carrying case may be size and configures to hold the protector after folding.

Although the foregoing description of the preferred embodiments has shown, described and pointed out certain novel features of the invention, it will be understood that various omissions, substitutions, and changes in the form of the detail as illustrated as well as the uses thereof, may be made by those skilled in the art, without departing from the scope of the invention. Particularly, it will be appreciated that the preferred embodiments may manifest itself in other shapes and configurations as appropriate for the end use of the article made thereby.

What is claimed is:

1. An apparatus for protecting a plant, comprising:
a protective covering, wherein the protective covering includes a means for opening and closing said protective covering;
an element releaseably attached to the protective covering;
a means for powering the element; and
a means for securing the protective covering around the plant.

2. The apparatus of claim 1 further comprising a timer operably connected to the element.

3. The apparatus of claim 1 further comprising a thermostat operably connected to the element.

4. The apparatus of claim 1, wherein the means for opening and closing the protective covering is in the form of a strip.

5. The apparatus of claim 1, wherein the means for powering the element is a power plug connected to an AC power source.

6. The apparatus of claim 1, wherein the means for powering the element is a power plug connected to an DC power source.

7. The apparatus of claim 1, wherein the means for powering the element is a rechargeable battery pack.

8. The apparatus of claim 1, wherein the means for powering the element is solar.

9. The apparatus of claim 1, wherein the means for securing the protective covering around the plant is a drawstring.

10. The apparatus of claim 1, wherein the protective covering is closed at its top end.

11. The apparatus of claim 1, wherein the protective covering is open at its top and bottom end.

12. An apparatus for protecting a plant, comprising:
a covering having a top and bottom end and a seam,
wherein the covering includes a releasable element in its interior that is powered for heating or cooling,
wherein the covering includes a means for opening and closing the seam and
wherein a means for securing the covering brings the covering in close proximity to the plant.

13. The apparatus of claim 21 further comprising a timer operably connected to the element.

14. The apparatus of claim 12 further comprising a thermostat operably connected to the element.

15. The apparatus of claim 12, wherein the means for opening and closing the protective covering is selected from the group consisting of one or a number of hook and latches, clamps, clasps, buttons, zippers, hooks and combinations thereof.

16. The apparatus of claim 12, wherein the releasable element is powered by one of the group selected from a power plug connected to an AC power source, a power plug connected to an DC power source, a rechargeable battery pack, a solar source.

17. The apparatus of claim 12, wherein the means for securing the protective covering around the plant is selected from the group consisting of a string, clamp, clasp, zipper, hook, latch, button, elastic, rubber band, and combinations thereof.

18. The apparatus of claim 12, wherein the protective covering is closed at its top end.

19. The apparatus of claim 12, wherein the protective covering is open at its top and bottom end.
